(19) United States
(12) Patent Application Publication
(10) Pub. No.: US 2010/0028233 A1
(43) Pub. Date: Feb. 4, 2010

(54) Method for Combustion of a Carbon-Containing Fuel, Especially a Fossil Fuel

(76) Inventors: Helmut Dreuscher, Wiehl (DE); Bernd Epple, Brensbach (DE); Ulrich Priesmeier, Gummersbach (DE); Helmut Tschaffon, Unterschleissheim (DE)

Correspondence Address: ROBERT W. BECKER & ASSOCIATES, 707 HIGHWAY 333, SUITE B, TIJERAS, NM, 87059-7507, US

(21) Appl. No.: 12/500,511

(22) Filed: Jul. 9, 2009

(30) Foreign Application Priority Data
Jul. 9, 2008 (DE) 10 2008 032 355.1

(51) Int. Cl. B01D 53/48

(52) U.S. Cl. 423/244.08

(57) ABSTRACT

A method for combustion of a carbon-containing fuel, especially a fossil fuel, further preferred coal. The flue gas is at least dedusted, is desulfurized with an absorbent containing calcium compounds, and in a two-stage high temperature process is decarbonized with calcium oxide in a carbonator accompanied by formation of calcium carbonate and the calcium carbonate is regenerated in a calcinator, while heat is supplied and while carbon dioxide is set free, to form calcium oxide, which is recirculated into the carbonator. At least to one of the stages of the high temperature process fresh calcium containing absorbent is added. Calcium compounds from the carbonator and/or calcinator are used as absorbent with the flue gas desulfurization.

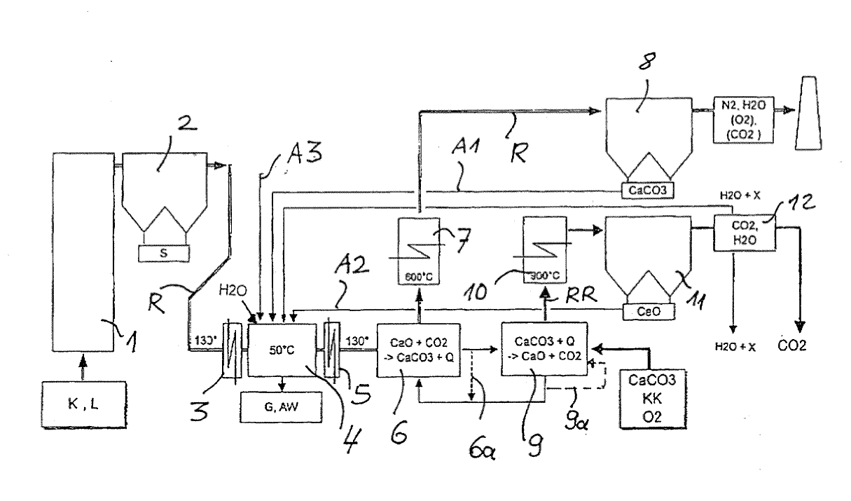

The instant application should be granted the priority date of Jul. 9, 2008, the filing date of the corresponding German patent application 10 2008 032 355.1.

### BACKGROUND OF THE INVENTION

The invention relates to a method for the combustion of a carbon-containing fuel, especially a fossil fuel, further preferred coal, with which the flue gas is at least dedusted, is desulfurized with an adsorbent containing calcium compounds, and in a two-stage high temperature process is decarbonized with calcium oxide in a carbonator along with the formation of calcium carbonate and the calcium carbonate is regenerated in a calcinator, while heat is supplied and while carbon dioxide is set free, to form calcium oxide, which is recirculated into the carbonator, while at least to one of the stages of the high temperature process fresh calcium containing absorbent is added.

For the desulfurization of flue gases (combustion gases), which can be performed with dry, semi-dry or wet processes, normally calcium compounds, are used as absorbents. With all the processes the calcium compounds, either in the form of dry solid matter or in the form of suspension, are intensively brought into contact with the SO₂ contained in the flue gas and with harmful gases (SO₃; HCl; HF) eventually also contained in the flue gas. By the absorption of SO₂ in the first place a calcium sulfite is formed, which thereafter, in dependency of the process, is oxidized to calcium sulfate by taking of oxygen.

As a fresh absorbent normally finely pulverized limestone (CaCO₃), hydrate of lime (Ca(OH)₂)) or quick lime (CaO) supplied to the desulfurization process. As end-product either a mixture of calcium sulfite and calcium sulfate is formed, which mixture has to be dumped, or in case of a wet flue gas desulfurization gypsum (CaSO₄×2 H₂O—calcium sulfate dihydrate) is formed, which can be used in the industry of building materials.

Besides the dedusting, desulfurization and decarbonization, a denoxing (removal of nitrogen oxides) may also be provided.

To take into account the problems of climate change, as an addition of the present flue gas cleaning a CO₂-separation (decarbonization) is also planned for future large-scale combustion plants (for example power plants). With the so-called Carbonate Looping the CO₂-separation takes place in a first high temperature process stage, in which granular quick lime (CaO) of a granular size up to several millimeters is used. In a carbonator the CaO reacts by absorption of CO₂ exothermically to limestone (calcium carbonate).

The limestone is then regenerated with heat supply in an endothermic further high temperature process stage in a calcinator to CaO, i. e. it is calcinated, while substantially pure CO₂ is split off or desorbed respectively. The heat supply can be achieved by heat exchange or by addition of coal and oxygen, due to the reaction of which the heat is provided. The CaO is recycled into the first high temperature process stage. With the use of limestone (CaCO₃) for the CO₂—separation a progressive deactivation of the CaO occurs with the number of cycles, so that fresh CaCO₃ has to be added and deactivated material has to be withdrawn from the process (Compare the http://www.est.tu-darmstadt.de/Carb-Loop.pdf Article: “CARBONATE LOOPING ZUR CO₂-ABSCHEIDUNG” of Apr. 20, 2007). It has to be assumed that the CaO changes its grain structure due to the multiple loading with CO₂ and the following regeneration. On the one hand pores form, which lead to a higher reactivity of the material; on the other hand the material reacts partly with the residual—SO₂, which is still contained in the flue gas after the desulfurization, to form calcium sulfite/sulfate. The calcium sulfate present is in such stable state that it will not disintegrate during the thermal regeneration, but will form a stable cover, which adversely affects the reactivity of the grain.

It is known that the drawn-off material can be used in the cement industry.

From U.S. Pat. No. 6,737,031 B2 a method of simultaneous reduction of the CO₂ and the SO₂ emission in a combustion plant is known, with which a calcium containing absorbent is injected into the furnace, a part of which after its decarbonization absorbs SO₂. The flue gases leaving the furnace are subjected to an intermediate cooling and enter a first reactor. Here that part of the absorbent contained in the flue gas, which has not reacted with SO₂, can capture CO₂ from the flue gas by carbonization. Thereafter, the solids contained in the flue gas are separated in a separator to subject the solids in a second reactor to a heat treatment to extract from them CO₂ by decarbonization. The produced regenerated CO₂ absorbent is recycled to the first reactor. During the decarbonization the SO₂ absorbed in the furnace is also set free. SO₂ and CO₂ can be separated from each other. With this method the desulfurization is performed in the furnace itself. Therefore, it especially cannot to be used for the retrofit of existing power plants having the desulfurization connected downstream of the furnace.

It is an object of the present invention to state a more optimal use for the drawn off material.

### SUMMARY OF THE INVENTION

With a method of the aforementioned general type, this object is realized in that calcium compounds from the carbonator and/or calcinator are used as absorbent with the flue gas desulfurization.

As a desulfurization method any one of the methods can be used as they are described on page 1 in the second paragraph.

The CaCO₃ used for the CO₂-separation is therefore used also for the desulfurization with great advantage for the overall process. It can at least replace part of the absorbent, which otherwise is used with the desulfurization.

Preferably the use takes place with a wet flue gas desulfurization plant. of 14

With the Carbonate-Looping-Process the used granular material is mechanically stressed and therefore is subjected to a wear generating abrasion material. The wear is caused by the transport from the carbonator to the calcinator and back. Further wear results from the preferred design of carbonator and calcinator as fluidized beds. The abrasion material mainly comes in a typical manner from the outer region of the grain and contains calcium sulfate, calcium oxide and/or calcium carbonate. In comparison to the residual grain the abrasion material has an essentially finer grain spectrum. Furthermore, the grains can disintegrate in case of strain. According to the invention the disintegration particles are counted to the abrasion material.

Thus, four different qualities are basically available as absorbent
material for the desulfurization:
   coarse grain material from the calcinator,
   abrasion material from the calcinator,
   coarse grain material from the carbonator and
   abrasion material from the carbonator.

Each of these qualities can be used alone or in combination with others for the flue gas desulfurization.

Preferably the processes of the CO₂-separation and/or the regeneration are carried out in such a manner that the abrasion material is separated from the residual grain and the abrasion material form the carbonator and/or the abrasion material from the calcinator may be used as absorbent. The fineness of the abrasion material is advantageous, because thereby the reactivity of the absorbent for the SO₂-separation is increased considerably.

Due to the artificial porosity and its share in CaO the material has a higher reactivity than the limestone used for the CO₂-separation.

The parts of calcium sulfate in the abrasion material are inert with respect to the SO₂-separation; they act, however, in case of a wet flue gas desulfurization as nuclei of crystallization for the formation of gypsum crystals. Therefore the separation output of the wet desulfurization is increased.

It is, however, also possible to use coarse grain from the carbonator and/or the calcinator as absorbent.

For the replacement of the material withdrawn from the Carbonate-Looping-Process due to the loss of activity, preferably CaCO₃ coming from natural sources is supplied directly to the calcinator as fresh absorbent. It is, however, also possible to supply the fresh absorbent at another point to the circulating absorbent of the Carbonate-Looping-Process directly or indirectly (for example via the flue gas stream).

Furthermore, it is obviously possible to feed other calcium containing materials, especially CaO, as fresh absorbent instead of or in combination with CaCO₃ from natural sources.

If the amount of the material withdrawn from the carbonator and/or from the calcinator is not sufficient for the flue gas desulfurization preferably CaCO₃ and/or CaO are supplied to the desulfurization as fresh absorbent.

It is furthermore advantageous, if waste water produced during a treatment of the generated carbon dioxide is supplied to the flue gas desulfurization.

It is also preferred that the flue gas is first desulfurized and next decarbonized.

The invention is also directed to the use of calcium compounds, which before have taken part in a high temperature process for decarbonizing of flue gas, as absorbent with a method for desulfurization of flue gas, especially in a wet desulfurization plant.

### BRIEF DESCRIPTION OF THE DRAWING

The invention will be explained subsequently by way of example with reference to the enclosed sole FIGURE, which shows fresh absorbent being supplied to the desulfurization and to the calcinator.

### DESCRIPTION OF SPECIFIC EMBODIMENTS

Coal K and air L are supplied to the boiler 1 of a power plant. The flue gas R withdrawn from the boiler 1 is dedusted in an electrostatic filter at 130° C. and the dust S is withdrawn. The dedusted flue gas R is cooled in a heat exchanger 3 and is led into a wet flue gas desulfurization plant or unit 4.

Supplied to the wet flue gas desulfurization plant 4 are water H₂O as well as an absorbent A1 (CaCO₃) and/or an absorbent A2 (CaO). A suspension is made of these, which suspension is admixed to the circulation suspension of the plant and is sprayed together with the latter into the flue gas R. A part of the water vaporizes or evaporates respectively, and decreases therewith the flue gas temperature to saturation temperature (about 50° C.). At this temperature the following gross desulfurization reactions occur:

CaCO₃+SO₂+0.5 O₂+2 H₂O→CaSO₄×2 H₂O+CO₂ (1a)

respectively

CaO+SO₂+½ O₂+2 H₂O→CaSO₄×2 H₂O (1b)

Gypsum G (CaSO₄×H₂O) and waste water AW are withdrawn from the desulfurization plant.

The flue gas withdrawn from flue gas desulfurization plant 4 is reheated in a further heat exchanger 5 to 130° C. The heat exchanger 3 and the heat exchanger 5 are part of a heat shifting system or together form a gas-gas-heat exchanger.

Afterwards, the flue gas enters a carbonator 6. In the carbonator an exothermic high temperature process stage occurs, by means of which the flue gas is heated:

CaO+CO₂→CaCO₃+Q (2)

The flue gas is withdrawn with a temperature in the range of 450° C.-750° C., preferably 600° C.-650° C., more preferred 600° C., from the carbonator via a heat exchanger 7. The abrasion material contained in the flue gas is separated in a separator 8 and substantially consists of CaCO₃. The separated abrasion material is supplied as absorbent A1 to the flue gas desulfurization plant 4. The flue gas R leaving the separator 8 substantially consists of N₂ and H₂O with small residues of O₂ and CO₂ and is supplied to the power plant chimney.

The CaCO₃ generated in the carbonator 6 is withdrawn and fed to a calcinator 9. In the calcinator the CaCO₃ is regenerated with the supply of heat in a second high temperature process stage according to the following equation:

CaCO₃+Q→CaO+CO₂ (3)

This process is endothermic. For the generation of the heat necessary for the endothermic process in the calcinator 9 coal KK and oxygen O₂ are supplied to the calcinator 9. Other fossil fuels, but also biomass, may be used.

Preferably the lay-out of the carbonator 6 and the calcinator 9 is in the form of fluidized beds. Further preferred the carbonator 6 is designed in form of a circulating fluidized layer with a recirculation line 6a, which is shown in broken lines in the FIGURE.

It may also be of advantage, if the calcinator 9 is designed as a circulation fluidized layer with a recirculation line 9a, which is shown in broken lines in the FIGURE.

The granular CaCO₃ necessary for the compensation of the withdrawn material is also supplied to the calcinator.

The flue gas RR withdrawn with a temperature of 900° C. and containing the abrasion material from the calcinatory 9 is led through a heat exchanger 10 and fed to a separator 11. The flue gas leaving the separator 11 contains the CO₂ desorbed in the calcinator and H₂O. In a separation stage 12 the water H₂O can be separated from CO₂ in the form of waste water H₂O+X. X designates any harmful materials, which are set free during the combustion of coal KK and are not bound as impurities to the CaO. They are separated in the separation stage 12 (condensation) and are supplied to the wet desulfurization plant 4 for material use or waste disposal, respectively. In the figure it is shown that also another way of withdrawal of the H₂O+X is possible.

The CO₂ can be compressed and thereafter e. g. stored underground.

The abrasion material contained in the flue gas RR will be separated in the separator 11 and substantially consists of CaO. The withdrawn abrasion material is supplied to the flue gas desulfurization plant 4 as absorbent A2. The fly ash particles from the combustion of the coal KK in the calcinator 9 and contained in the absorbent A2 influence the quality of the gypsum G withdrawn from the flue gas desulfurization plant 4 only to an unimportant degree.

If the amounts of resulting absorbent A1 and/or A2 are not sufficient, additional fresh absorbent A3 (CaCO₃; CaO) is supplied to the flue gas desulfurization plant.

The heat extracted in the heat exchangers 7 and 10 can preferably be fed into the water-steam-circuit of the power plant.

If not all material to be withdrawn from the quick lime-limestone-cycle can be used in the desulfurization of the power plant, the material has to be disposed otherwise. For example, it can also be used for desulfurization at another place or it can be used in the building material industry.

The specification incorporates by reference the disclosure of German priority document DE 10 2008 032 355.1 filed Jul. 9, 2008.

The present invention is, of course, in no way restricted to the specific disclosure of the specification and drawings, but also encompasses any modifications within the scope of the appended claims.

1. A method for combustion of a carbon-containing fuel, and for treating the resulting flue gas, said method including the steps of:
removing dust from the flue gas,
desulfurizing the flue gas with an absorbent that contains calcium compounds,
in a first stage of a two-stage high temperature process, decarbonizing the flue gas in a carbonator by means of calcium oxide accompanied by the formation of calcium carbonate,
in a second stage of the two-stage high temperature process, regenerating the calcium carbonate in a calcinator, accompanied by the supply of heat and the release of carbon dioxide, to form calcium oxide,
recirculating the calcium oxide that is formed into said carbonator,
adding fresh calcium-containing absorbent to at least one of the stages of the high temperature process, and
using calcium compounds from at least one of said carbonator and said calcinator as absorbent in said step of desulfurizing the flue gas.

2. A method according to claim 1, wherein abrasion material is separated from the flue gas downstream of said carbonator, and wherein said abrasion material is used as absorbent.

3. A method according to claim 1, wherein abrasion material is separated from the gas stream downstream of said calcinator, and wherein said abrasion material is used as absorbent.

4. A method according to claim 1, which includes the further step of using coarse grain from said carbonator as absorbent.

5. A method according to claim 1, which includes the further step of using coarse grain from said calcinator as absorbent.

6. A method according to claim 1, which includes the further step of supplying at least one of CaCO₃ and CaO to said step of desulfurizing the flue gas as fresh absorbent.

7. A method according to claim 1, wherein waste water is produced in said regenerating step during the release of carbon dioxide, and wherein said waste water is supplied to said step of desulfurizing the flue gas.

8. A method according to claim 1, wherein said step of decarbonizing the flue gas follows said step of desulfurizing the flue gas.

9. The use of calcium compounds that have previously taken part in a high temperature process for decarbonizing flue gas, including the step of using said calcium compounds as absorbent in a method of desulfurizing flue gas.

10. The use of calcium compounds according to claim 9, which includes the further step of using said calcium compounds in a wet flue gas desulfurization plant.
